(19) United States
(12) Patent Application Publication
(10) Pub. No.: US 2004/0224249 A1
(43) Pub. Date: Nov. 11, 2004

(54) Self-contained imaging assembly with increased resistance to peeling

(76) Inventors: Bradley A. Paulson, Northfield, MN (US); Darren W. Haas, Bloomington, MN (US); I. Tony Haugen, Minnetonka, MN (US); Robert J. Innes, Savage, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/797,471

(22) Filed: Mar. 10, 2004

Related U.S. Application Data
(60) Provisional application No. 60/453,376, filed on Mar. 10, 2003.
(60) Provisional application No. 60/453,377, filed on Mar. 10, 2003.

(51) Int. Cl. G03C 1/72

(52) U.S. Cl. 430/211

(57) ABSTRACT

A self-contained imaging system includes a first support, a second support, an imaging layer, and a subbing layer. The imaging layer is capable of producing an image that is viewable through said first support and it is positioned intermediate the first and second supports; the first and second supports are sealed together to present an integral unit. The subbing layer is presented between the first support and the imaging layer. The subbing layer promotes adhesion between the supports and imaging layer, and is preferably selected from a surface pretreatment of the first support with a polyester film or placement of a thermo set material, e.g., a polyester-urethane adhesive.

### CLAIM TO PRIORITY

The present application claims priority to U.S. Provisional Application No. 60/453,376, filed Mar. 10, 2003 and entitled “Support For Self-Contained Imaging Assembly Having Improved Peel Strength” and to U.S. Provisional Application No. 60/453,377, filed Mar. 10, 2003, and entitled “Manufacturing Of Self-Contained Imaging Assembly For Identification Card Applications.” Each of the identified provisional patent applications is hereby incorporated by reference.

### FIELD OF THE INVENTION

The present invention relates to self-contained imaging assemblies and, more particularly to self-contained imaging assemblies with increased resistance to peeling.

### BACKGROUND OF THE INVENTION

Self-contained imaging assemblies are described in U.S. Pat. Nos. 4,440,846, 5,783,353, 6,037,094, 6,127,084, and 6,387,585, each of which is hereby incorporated by reference. Each discloses a self-contained imaging assembly wherein a layer of microcapsules containing a chromogenic material and a photohardenable or photosoftenable composition, and a developer that may be in the same or a separate layer from the microcapsules, is image-wise exposed. When image-wise exposed, the microcapsules rupture and an image is produced by the differential reaction of a chromogenic material and the developer. U.S. Pat. No. 5,783,353 more specifically discloses a self-contained media in which the photosensitive microcapsules and the developer are sealed between two plastic films such that the user never comes into contact with the chemicals which form the image unless the media is deliberately destroyed. U.S. Pat. No. 6,387,585 (hereafter, the '585 patent) more specifically discloses a self-contained media in which the photosensitive microcapsules and the developer are sealed between two plastic films with an increased resistance to peeling by addition of specific adhesion promoters.

In the self-contained imaging system of the '585 patent, the imaging layer comprises a developer, photohardenable microcapsules and an adhesion promoter. The imaging layer is sealed between two support members to form an integral unit having improved peel strength. This sealed format is advantageous because it prevents the developer material and the contents of the microcapsules from contacting persons during handling and, depending on the nature of the supports, it may also prevent oxygen from permeating into the photohardenable material which may improve film speed and the stability of the image. The term “sealed” as used herein refers to a seal, which is designed as a non-temporary seal, which results in destruction of the imaging assembly if the seal is broken. Adhesion promoters used in accordance with the '585 disclosure increase cohesion and adhesion within and between the layers of the composite imaging sheet to produce an imaging system having improved peel strength. The peel strength provides an indication of the integrity of the composite, self-contained imaging system. Increasing the peel strength of the imaging system insures that the benefits associated with having a sealed system are not compromised.

In the imaging assembly of the '585 patent, the previously mentioned first support is transparent and the second support may be transparent or opaque. In the latter case, an image is provided against a white background as viewed through the transparent support and in the former case a transparency is provided in which the image is viewed as a transparency preferably using an overhead or slide projector. Sometimes herein, the first support may be referred to as the “front” support and the second support may be referred to as the “back” support.

To ensure that the imaging system of the '585 patent is effectively sealed between the supports, a subbing layer is provided between the supports, a subbing layer is provided between one of the supports and the imaging layer, and an adhesive is provided between the other support and the imaging layer. For optical clarity, the subbing layer is typically located between the first support and the imaging layer. However, which support receives the subbing layer and which support receives the adhesive is a function of which support is coated with the wet imaging layer composition and which is assembled with the coated and dried imaging layer. The support which is coated with the imaging layer composition (which is typically the front support) will be provided with the subbing layer and the support which is assembled with the dried imaging layer will receive the adhesive.

Further, with regard to the '585 patent, the use of an imaging layer containing both the microcapsules and the developer is desirable because the image is formed in direct contact with the front transparent support through which the image is viewed. It has been found that this provides better image quality than, for example, providing a developer layer which overlies a separate layer of microcapsules, because the assembly can be exposed and viewed from the same side, the image can be viewed against a white background (when the back support is opaque) and, the image lies directly under the support through which it is viewed where it is most intense.

While the current state of technology is able to provide a self-contained imaging assembly, to do so it uses a thermoplastic subbing layer. This thermoplastic subbing layer flows when exposed to temperatures above some transition point. As a result, upon exposure to heat, the subbing layer fails, allowing the first support to be easily removed from the structure, exposing the imaging layer to the environment. Further, unless the first support is securely attached to the imaging layer, additional features such as holographic images for security or magnetic strips for access control, cannot be included in the first support.

### SUMMARY OF THE INVENTION

The limitations described above are in large part addressed by the self-contained imaging system of the present invention. Specifically, a self-contained imaging system includes a first support, a second support, an imaging layer, and a subbing layer. The imaging layer is capable of producing an image that is viewable through said first support and it is positioned intermediate the first and second supports; the first and second supports are sealed together to present an integral unit. The subbing layer is presented between the first support and the imaging layer. The subbing layer promotes adhesion between the supports and imaging layer, and is preferably selected from a surface pretreatment of the first support with a polyester film or placement of a thermo set material, e.g., a polyester-urethane adhesive.

With the above described self-contained imaging system/assembly, the first support may additionally include a UV blocking compound, an optically variable device, an anti-static coating, or magnetic recording media.

A method for making a self-contained imaging assembly includes the steps of: (1) presenting a first support; (2) providing a subbing layer proximate the first support; (3) providing an imaging layer proximate the subbing layer; (4) providing a second support proximate the imaging layer; and (5) sealing the second support to the first support to form an integral unit. The step of providing a subbing layer may include pretreating the first support with a polyester film or placing a thermo set material intermediate the first support and imaging layer.

A self-contained imaging assembly may also include an imaging means, a first support means, a second support means, and a subbing means. The imaging means is for creating an image from a plurality of photosensitive microcapsules when said photosensitive microcapsules are placed under pressure. The first support means is for partially enclosing the imaging means as is the second support means. However, the first and second support means are sealed together to form an integral unit. The subbing means is for promoting adhesion between the imaging means and the support means. The subbing means is selected from a polyester film or a thermo set material.

### BRIEF DESCRIPTION OF THE DRAWINGS

FIG. 1 depicts that layers the form that self-contained imaging system of the present invention.

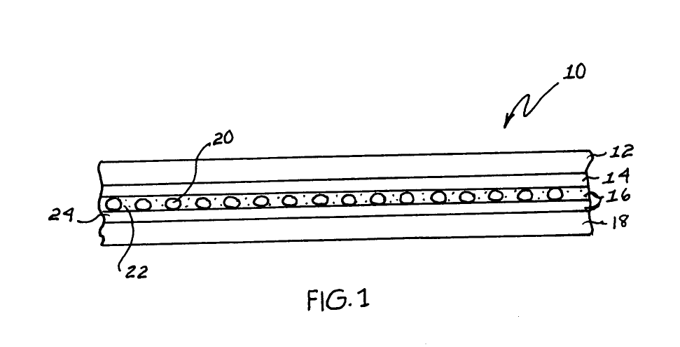

### DETAILED DESCRIPTION OF THE PREFERRED EMBODIMENTS

In the self-contained imaging system of the present invention, the imaging layer is sealed between two support members to form an integral unit. The sealed format is advantageous because it prevents the developer material and the contents of the microcapsules from contacting persons during handling and, depending on the nature of the supports, it enables incorporation of additional features in the support such as antistatic coatings to facilitate media transport during printing, UV blockers or inhibitors to protect the developed images, and magnetic strips and optical variable devices for final applications. In accordance with the present invention, the thermoplastic subbing layer of the prior art is replaced with an appropriate surface treatment or thermo set material. The subbing layer, presented on the first support, enhances the structural integrity of the imaging system, even after exposure to elevated temperatures, insuring that the integrity of the system is maintained.

To record images, the imaging material can be scanned with an LED print head and developed by application of pressure to the unit. An image appears on the face of the unit. The media can be printed using a printer which incorporates an LED print head in combination with one LED/developer head of the type described in U.S. Pat. No. 5,550,627, which is hereby incorporated by reference. Of course, the media can be exposed and developed using any of the exposure and developing equipment that is taught in the art as it relates to imaging materials employing photosensitive microcapsules of this type, e.g., laser scan, LCD, laser-addressed LCD, reflection imaging, etc.; also see U.S. patent application Ser. No. 10/677,762, filed Oct. 2, 2003, and entitled “Card Printing System and Method”, hereby incorporated by reference.

As such, in accordance with the preferred embodiment of the invention, a self-contained imaging system 10 comprises in order: a first transparent support 12, a subbing layer 14 between the first transparent support 12, the imaging layer 16, and a second support 18 that may or may not contain an opacifying agent. The imaging layer 16 comprises an imaging composition comprising photohardenable microcapsules 20 and a developer material 22, and a layer of adhesive 24 to bond the imaging layer 16 to the second support 18.

Images are formed in the present invention in the same manner as described in U.S. Pat. No. 4,440,846, which is hereby incorporated by reference. By image-wise exposing this unit to actinic radiation, the microcapsules are differentially hardened in the exposed areas as taught in U.S. Pat. No. 4,440,846. The exposed unit is subjected to pressure to rupture the microcapsules.

The self-contained imaging system 10 after exposure and rupture of the microcapsules forms an image. The ruptured microcapsules release a color forming agent, whereupon the developer material 22 reacts with the color forming agent to form the image. The image formed is viewed through the transparent support 12 against the support 18 which can contain a white pigment. Typically, the microcapsules consist of three sets of microcapsules sensitive respectively to red, green and blue light and containing cyan, magenta and yellow color formers, respectively, as taught in U.S. Pat. No. 4,772,541, which is hereby incorporated by reference. Also useful in the present invention is a silver-based photohardenable microencapsulated system such as that described in U.S. Pat. Nos. 4,912,011; 5,091,280, and 5,118,590 (all of which are hereby incorporated by reference) and other patents assigned to Fuji Photo Film Co. Preferably, a direct digital transmission imaging technique is employed using a modulated LED print head as mentioned above.

Imaging layer 16 typically contains about 20 to 80% (dry weight) of the developer, about 80 to 20% (dry weight) microcapsules, about 0 to 20% (dry weight) binder and about 0.01 to 10%, preferably 0.5 to 5% of an adhesion promoter. The layer is typically applied in a dry coat weight of about 8 to 20 g/m². Binder materials that may be utilized include polyvinyl alcohol, polyacrylamide, and acrylic lattices.

In the self-contained photohardenable imaging system 10, the first transparent support 12 through which the image is viewed can be formed from any transparent polymeric film. A film is selected that provides good photographic quality when viewing the image. Preferably, a film is used that is resistant to yellowing. The first support 12 is typically a transparent polyethylene terephthalate (PET) support.

In a preferred embodiment, the first support 12 has a surface pretreatment to promote adhesion of the dry imaging layer. Preferred examples include, but are not limited to, the polyester films of Melinex™ 582 and Mylar™ 123, both of which are available from Dupont Teijin Films. In a second preferred embodiment, the first support 12 has a thermo set material as the subbing layer 14. Preferred examples of the thermo set material include, but are not limited to, W11, W35, and W60 polyester-urethane adhesives from Waytek Corporation. In alternative embodiments, the first support 12 may contain UV blocking compounds to inhibit UV that induces degradation of the image produced by the developed dyes; the first support 12 may contain an optically variable device, such as, but not limited to, a holographic image, as a security feature in the final developed product; the first support 12 may posses an anti-static coating on the side opposite the imaging layer to facilitate transport of the self-contained imaging media through a printing apparatus; and the first support may possess magnetic recording media on the side opposite the imaging layer to enable the use of self-contained imaging media with a magnetic strip reader/writer.

The second support 18 is preferably an opaque support such as polyethylene terephthalate (PET) containing an opacifying agent, paper or paper lined with film (polyethylene, polypropylene, polyester, etc.). Most preferably, the opaque support is a polyethylene terephthalate support containing about 10% titanium dioxide which provides a bright white opaque support. This support is commercially available from ICI, Ltd. under the product designation Melinex™. Typically, each of the front and back PET supports has a thickness of about 2 to 4 mils.

Some other products which are useful include paper cardboard, polyethylene, polyethylene-coated paper, etc. Opaque films are composites or admixtures of the polymer and the pigment in a single layer, films or coated papers. Alternatively, the opacifying agent can be provided in a separate layer underlying or overlying a polymer film such as PET. The opacifying agent employed in these materials is an inert, light-reflecting material that exhibits a white opaque background. Materials useful as the opacifying agent include inert, light-scattering white pigments such as titanium dioxide, magnesium carbonate or barium sulfate. In a preferred embodiment, the opacifying agent is titanium dioxide.

In a preferred embodiment, the imaging layer of the present invention is employed in the construction of a two-sided imaging material in accordance with U.S. Pat. No. 6,037,094, which is hereby incorporated by reference. The two-sided imaging material comprises a pair of transparent supports, an opaque support and an imaging layer disposed between each transparent support and the opaque support. The benefits provided by the imaging layer of the present invention are particularly useful in a two-sided imaging material. Adhesion and cohesion characteristics of the composite coating are believed to be more important in a two-sided imaging material because of the additional layers involved in the construction of the imaging assembly.

In accordance with one embodiment of the invention, a full color imaging system 10 is provided in which the microcapsules are in three sets respectively containing cyan, magenta and yellow color formers sensitive to red, green, and blue light, respectively. However, digital imaging systems do not require the use of visible light and as such, sensitivity can be extended into the UV and IR. For optimum color balance, the visible-sensitive microcapsules are sensitive (.lambda.max) at about 450 nm, 540 nm, and 650 mn, respectively. Such a system is useful with visible light sources in direct transmission or reflection imaging. Such a material is useful in making contact prints, projected prints of color photographic slides, or in digital printing. They are also useful in electronic imaging using lasers or pencil light sources of appropriate wavelengths.

The photohardenable composition in at least one and possibly all three sets of microcapsules can be sensitized by a cationic dye-borate complex as described in U.S. Pat. No. 4,772,541, which is hereby incorporated by reference. Because the cationic dye-borate anion complexes absorb at wavelengths greater than 400 nm, they are colored and the unexposed dye complex present in the microcapsules in the non-image areas can cause undesired coloration in the background area of the final picture. Typically, the mixture of microcapsules is greenish and can give the background areas a greenish tint. Means for preventing or reducing undesired coloration in the background as well as the developed image include reducing the amount of photoinitiator used and adjusting the relative amounts of cyan, magenta and yellow microcapsules. In this regard, it is desirable to include a disulfide compound in the photosensitive composition to reduce the amount of dye-borate that may be required as described in detail in U.S. Pat. No.5,783,353, which is hereby incorporated by reference.

The photohardenable compositions of the present invention can be encapsulated in various wall formers using techniques known in the area of carbonless paper including coacervation, interfacial polymerization, polymerization of one or more monomers in an oil, as well as various melting, dispersing, and cooling methods. To achieve maximum sensitivities, it is important that an encapsulation technique be used which provides high quality capsules which can be differentially ruptured based upon changes in the internal phase viscosity. Because the dye-borate tends to be acid sensitive, encapsulation procedures conducted at higher pH (e.g., greater than about 6) are preferred.

Melamine-formaldehyde capsules are particularly useful. It is desirable in the present invention to provide a pre-wall in the preparation of the microcapsules. See U.S. Pat. No. 4,962,010, which is hereby incorporated by reference, for a particularly preferred encapsulation using pectin and sulfonated polystyrene as system modifiers. The formation of pre-walls is known, however, the use of larger amounts of the polyisocyanate precursor is desired. A capsule size should be selected which minimizes light attenuation. The mean diameter of the capsules used in this invention typically ranges from approximately 1 to 25 microns. As a general rule, image resolution improves as the capsule size decreases. Technically, however, the capsules can range in size from one or more microns up to the point where they become visible to the human eye.

The developer materials and coating compositions containing the same conventionally employed in carbonless paper technology are useful in the present invention. Illustrative examples are clay minerals such as acid clay, active clay, attapulgite, etc.; organic acids such as tannic acid, gallic acid, propyl gallate, etc.; acid polymers such as phenol-formaldehyde resins, phenol acetylene condensation resins, condensates between an organic carboxylic acid having at least one hydroxy group and formaldehyde, etc.; metal salts of aromatic carboxylic acids or derivatives thereof such as zinc salicylate, tin salicylate, zinc 2-hydroxy napththoate, zinc 3,5 di-tert butyl salicylate, zinc 3,5-di-(a-methylbenzyl) salicylate, oil soluble metals salts or phenol-formaldehyde novolak resins (e.g., see U.S. Pat. Nos. 3,672,935 and 3,732,120, which are hereby incorporated by reference) such as zinc modified oil soluble phenol-formaldehyde resin as disclosed in U.S. Pat. No. 3,732,120, zinc carbonate etc., and mixtures thereof. The preferred developer material is one which will permit room temperature development such as zinc salicylate and particularly a mixture of zinc salicylate with a phenol formaldehyde resin. Especially preferred for use is a mixture of zinc salicylate or a zinc salicylate derivative and phenol-formaldehyde resin and, more particularly, a mixture of 25% HRJ 11177, a phenolic resin from Schenectady Chemical Company and 75% zinc salicylate. The particle size of the developer material is important to obtain a high quality image. The developer particles should be in the range of about 0.2 to 3 microns and, preferably in the range of about 0.5 to 1.5 microns.

A preferred developer material is one which has excellent compatibility with the microcapsule slurry solution. Many materials, including zinc salicylate and some phenolic resin preparations, have marginal or poor compatibility with the MF microcapsule preparation and result in agglomeration which is believed to be due to an incompatibility in the emulsifiers used in preparing the microcapsules and in the developer. The problem manifests itself in increasing solution viscosities or in instability of the microcapsules wall (or both). The microcapsules may become completely disrupted with a complete breakdown or disintegration of the wall. The problem is believed to be caused by the presence of water soluble acid salts in the developer solution. By modifying the acidic salts to make them water insoluble the developer material becomes compatible with the MF microcapsules. Examples of preferred developers which have good stability with MF microcapsules include HRJ-4250 and HRJ-4542 available from Schenectady International.

A suitable binder such as polyethylene oxide, polyvinyl alcohol (PVA), polyacrylamide, acrylic lattices, neoprene emulsions, polystyrene emulsions and nitrile emulsions, etc., may be mixed with the developer and the microcapsules, typically in an amount of about 1 to 8% by weight, to prepare a coating composition.

The use of appropriate dispersing agents can enhance the adhesion performance of the adhesion promoters of the present invention. This synergistic effect is particularly evident when the dispersing agents are used in conjunction with phenylcoumarin adhesion promoters. Materials that can be used as dispersants in the present invention include partially and fully hydrolyzed polyvinyl alcohol, polyacrylic acid and sodium salts thereof, polyacrylates, and metal salts of condensed arylsulphonic acids. Representative examples of commercially available dispersants useful in the present invention include Rhoplex®, Acumer®, and Tamol® available from Rohm & Haas, Acronal® available from BASF and Joncryl® available from Johnson Wax.

The dispersant concentration in the imaging system of the present invention can be varied over a wide range, with the upper limit being determined only by economical and practical considerations based on what properties are desired in the final product. It is preferred that the upper limit be about 10%, more preferably 8%, and most preferably about 5%, by weight of the developer resin. The preferred lower limit is about 0.5%. A more preferred lower limit is about 1.0%, with about 1.5% by weight, based on the total weight of the developer resin, being the most preferred lower limit. The dispersant of the invention is an optional additive and can be used either alone or in combination with other dispersants.

Fillers may be incorporated into the imaging layer of the present invention to improve further the cohesive strength of the coating layer and hence the overall binding capability of the layer within the PET substrates is increased tremendously. Such additives include oxides, carbonates and sulfates of metals such as calcium, aluminum, barium, silicon, magnesium, sodium and mixtures of said oxides, carbonates and sulfates, such as tricalcium aluminate hexahydrate, sodium aluminosilicate, aluminum silicate, calcium silicate, barium sulfates (barytes), clays, talc, micas, and mixtures thereof.

Commercially available fillers useful in the present invention include Diafil 590® (CR Minerals), Ultrex 95® (Engelhard), Opti-white (Burgess Inc.), CaCO₃ (OMYA, Inc.), hydrophobic and hydrophilic amorphous silica (Wacker), Zeolex®, and Hysafe® 310 (Huber Corp.).

In comparison testing, 90 degree peels were performed on the product of the present invention, and compared against Cycolor media as well as Fujicolor Crystal Archive Paper Supreme. The results are tablulated below:

TABLE 1
90 Degree Peel Force of Photographic Media

| Media | Comments | g/10 mm | lb/in |
|---|---|---|---|
| Cycolor Media | cohesive failure of | 25 | 0.1 |
| | active coating | | |
| Fujicolor Crystal | cohesive failure of | 125 | 0.7 |
| Archive Paper Supreme | paper core | | |
| Self-Contained | Cohesive failure of | 175 | 1.0 |
| Imaging Assembly | active coating | | |
| Self-Contained | Cohesive fail of | 1350 | 7.6 |
| Imaging Assembly | PSA to PVC core | | |

As seen in the table, the self-contained imaging assembly of the present invention exhibits significantly higher peels than either the Cycolor or Fujifilm medias. The standard Cycolor media contains the active components for developing images. Specifically, the Cycolor provides a product wherein a coating is applied as a liquid to a film (generally a clear polyester) pretreated or with a subbing (adhesive) layer to enhance adhesion of the coating. After drying, a dry coating is bonded with an adhesive (generally a pressure-sensitive adhesive (PSA) to a second film (generally an opaque, while polyester) to make photo sensitive “film.”

The self-contained imaging assembly as presented for testing comprised a first support 12 having a pretreatment or subbing layer 14 over which the wet coating (i.e., photohardenable microcapsules 20 and developer 24) was applied. After drying, the now active cylithographic coating, containing the photoharendable microcapsules and developer, was bonded to the second support 18 with the adhesive 24. A thermo set adhesive was used as adhesive layer 24 over the second support 18, exhibiting superior adhesion of the cylithographic coating to the tape test.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed:

1. A self-contained imaging assembly comprising:
a first support,
a second support, wherein said first and second support are sealed together to form an integral unit;
an imaging layer, positioned intermediate said first and second supports, wherein said imaging layer is capable of producing an image that is viewable through said first support; and
a subbing layer, wherein said subbing layer is intermediate said first support and said imaging layer, and wherein said subbing layer is selected from a polyester film or a thermo set material.

2. The assembly of claim 1, wherein said polyester film is applied as a pretreatment to said first support.

3. The assembly of claim 1, wherein said thermo set material comprises a polyester-urethane adhesive.

4. The assembly of claim 1, wherein said first support includes a UV blocking compound.

5. The assembly of claim 1, wherein said first support includes an optically variable device.

6. The assembly of claim 1, wherein said first support includes an anti-static coating.

7. The assembly of claim 1, wherein said first support includes magnetic recording media.

8. A method for making a self-contained imaging assembly, comprising the steps of:
presenting a first support;
providing a subbing layer proximate said first support;
providing an imaging layer proximate said subbing layer;
providing a second support proximate said imaging layer; and
sealing said second support to said first support to form an integral unit, wherein said step of providing a subbing layer comprises pretreating said first support with a polyester film or placing a thermo set material intermediate said first support and said imaging layer.

9. The method of claim 8, wherein the pretreatment with a polyester film promotes adhesion of a dry imaging layer.

10. The method of claim 8, wherein said thermo set material comprises a polyester-urethane adhesive.

11. The method of claim 8, further comprising the step of providing said first support with a UV blocking compound.

12. The method of claim 8, further comprising the step of providing said first support with an optically variable device.

13. The method of claim 8, further comprising the step of providing said first support with an anti-static coating.

14. The method of claim 8, further comprising the step of providing said first support with magnetic recording media.

15. A self-contained imaging assembly, comprising:
imaging means for creating an image from a plurality of photosensitive microcapsules when said photosensitive microcapsules are placed under pressure;
first support means for partially enclosing said imaging means;
second support means for partially enclosing said imaging means, wherein said first and second support means are sealed together to form an integral unit; and
subbing means for promoting adhesion between said imaging means and said first and/or second support means, wherein said subbing means is intermediate said imaging means and said first support means, and wherein said subbing means selected from a polyester film or a thermo set material.

16. The assembly of claim 15, wherein said thermo set material comprises a polyester-urethane adhesive.

17. The assembly of claim 15, wherein said first support means includes a UV blocking compound.

18. The assembly of claim 15, wherein said first support means includes an optically variable device.

19. The assembly of claim 15, wherein said first support means includes an anti-static coating.

20. The assembly of claim 15, wherein said first support means includes magnetic recording media.
